(19) United States
(12) Patent Application Publication
(10) Pub. No.: US 2010/0157153 A1
(43) Pub. Date: Jun. 24, 2010

(54) Upgrading Non-Volatile Storage Via an Encoded Video Signal

(75) Inventors: Bruce Plotnick, Furlong, PA (US); Gerald Roletter, Philadelphia, PA (US); Yan Li, Newtown, PA (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Advanced Micro Devices, Inc., Sunnyvale, CA (US)

(21) Appl. No.: 12/623,104

(22) Filed: Nov. 20, 2009

Related U.S. Application Data
(60) Provisional application No. 61/116,530, filed on Nov. 20, 2008.

(51) Int. Cl. H04N 7/025; H04N 7/16; H04N 7/167; H04B 1/66

(52) U.S. Cl. 348/467; 725/152; 725/31; 348/478; 375/240.25; 348/E07.017; 375/E07.027

(57) ABSTRACT

Systems for generating and transmitting a video stream that is encoded with program data such that when decoded can be executed to update non-volatile storage within a video based electronic device. Typically video based electronic devices are controlled by processors running software stored in writable, non-volatile storage. It is often desirable or necessary to update the software after the device has been shipped from a factory in order to correct a software failure discovered after shipment or to incorporate a new set of features. As many video based electronic devices have no common interface available to connect a computer, there is no ability to receive a software update. However, most video based electronic devices can be connected to a video source. Therefore, systems that allow a video based electronic device to receive, decode, and execute program data that is encoded within a video stream are presented. A method for encoding program code into a video stream is also presented.

### CROSS-REFERENCE TO RELATED APPLICATIONS

This application claims benefit to U.S. Provisional Application No. 61/116,530, filed on Nov. 20, 2009, which is incorporated by reference herein its entirety.

### BACKGROUND OF THE INVENTION

1. Field of the Invention

The present invention relates to video based electronics.

2. Related Art

Modern display devices, such as computer monitors, digital televisions, and video projectors, are often controlled by processors executing software stored in writable, non-volatile storage such as flash memory. It is often desirable, and sometimes necessary, to upgrade or update the software after the display device has been shipped from the manufacturer. Such software upgrades and updates are often required to incorporate new features, or are used to fix an issue discovered after the display device has been shipped from the manufacturer. Typically, display devices have no common interface accessible in which the display device can be connected to a computer in order to receive a software upgrade. However, all display devices can be connected to a video source as their primary function is to display a video image.

What are needed, therefore, are systems and/or methods to alleviate the aforementioned deficiencies. Particularly, what is needed is an approach to update software in video based electronics utilizing a video source interface.

### BRIEF SUMMARY

Consistent with the principles of the present invention as embodied and broadly described herein, the present invention includes a video signal source and a video based electronic device wherein the video based electronic device contains at least one processing unit whose programming instructions are stored in writable, non-volatile memory. The video signal source transmits a video signal with software code encoded within the video stream. The video based electronic device receives the video signal, detects that the video signal is encoded with software, extracts the encoded software, wherein a processing unit within the video based electronic device executes the encoded software.

In another embodiment, the encoded software code is encrypted within the video stream. The video based electronic device detects the encryption and decrypts the software code for execution.

In another embodiment, the video signal source comprises an electronic device configured to display video which may include the playing of video stored on a non-transitory, tangible medium, for example a DVD, semiconductor storage unit, CD-ROM, or magnetic storage medium.

In yet another embodiment, the video signal source comprises a broadcast device whereby the software code is encoded within the video broadcast stream. The broadcast video stream would be received and sent to the video based electronic device for execution.

In yet another embodiment, the video signal source comprises a global communications network whereby the software code is encoded within a video broadcast stream distributed through the network. The video stream would be received and sent to the video based electronic device for execution.

Further embodiments, features, and advantages of the invention, as well as the structure and operation of the various embodiments of the invention are described in detail below with reference to accompanying drawings.

### BRIEF DESCRIPTION OF THE FIGURES

The accompanying drawings, which are incorporated in and constitute part of the specification, illustrate embodiments of the invention and, together with the general description given above and the detailed description of the embodiment given below, serve to explain the principles of the present invention. In the drawings:

FIG. 1 is a system diagram depicting an implementation of a system for encoding program data within a video stream and the transmission of the video stream to a video based electronic device in accordance with the present invention.

FIG. 2 is a system diagram depicting an implementation of a system for encoding program data within a video stream and the transmission of the video stream to a video based electronic device utilizing a global communications network in accordance with the present invention.

FIG. 3 is an example of a possible human readable display of information during the transmission of a video stream with encoded program data to a video based electronic device.

FIG. 4 is another example of a possible human readable display of information during the transmission of a video stream with encoded program data to a video based electronic device.

FIG. 5 is a flowchart of an exemplary method of practicing an embodiment of the present invention.

### DETAILED DESCRIPTION

While specific configurations, arrangements, and steps are discussed, it should be understood that this is done for illustrative purposes only. A person skilled in the pertinent art(s) will recognize that other configurations, arrangements, and steps may be used without departing from the spirit and scope of the present invention. It will be apparent to a person skilled in the pertinent art(s) that this invention may also be employed in a variety of other applications.

It is noted that references in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of one skilled in the art to incorporate such a feature, structure, or characteristic in connection with other embodiments whether or not explicitly described.

The present invention relates to the transmission, encoding, receiving, decoding, and execution of software by a video based electronic device. In embodiments of this invention, software code is encoded within a video signal and then transmitted to a video based electronic device wherein the video based electronic device detects that software code is encoded in the video signal and decodes the software code for execution within a processing unit to update and/or upgrade internal software.

While the present invention is described herein with reference to illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

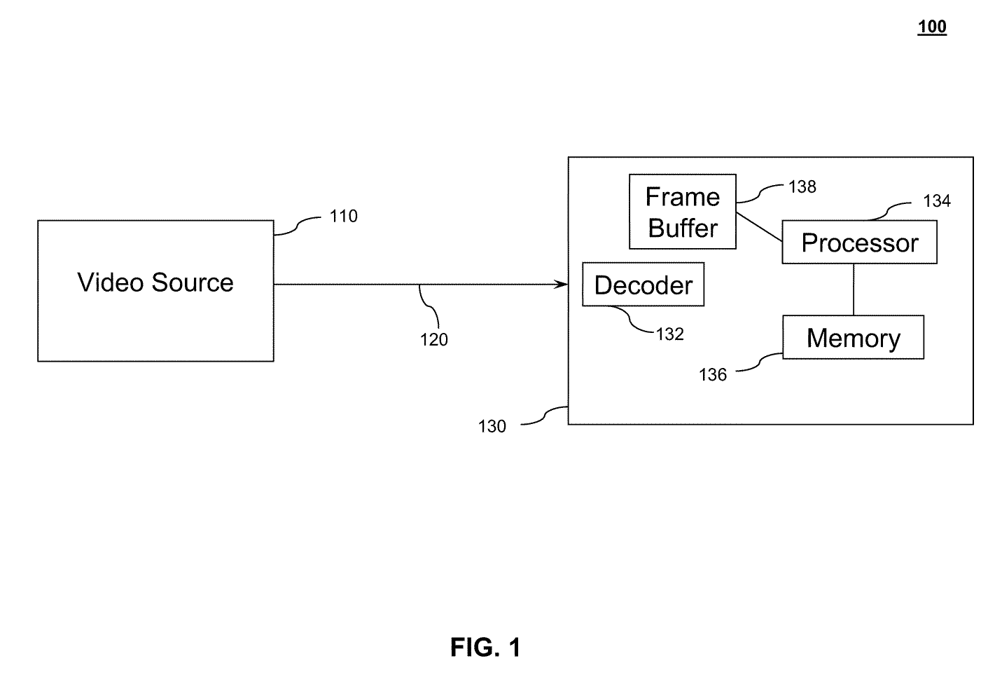

FIG. 1 is an illustration of a system 100 for a video based software code update system according to an embodiment of the invention. System 100 contains two primary components, video source 110 and video based electronic device 130, with a communication access 120 between video source 110 and video based electronic device 130.

Video source 110 may include a wide variety of devices, for example, a video recorder, a digital video recorder, a video player, a personal video recorder, a DVD player, a CD player, a computer, a digital camera, a video broadcast source, or similar electronic based device capable of outputting a video signal referred to as video signal 120 in FIG. 1. Correspondingly, video based electronic device 130 is capable of receiving video signal 120 and displaying the received video signal on some type of display device. Video based electronic device 130 also comprises a wide variety of devices, for example, a digital television, a portable video device, a liquid crystal display unit, a computer monitor, a projection unit, or similar electronic based device with a display. Video based electronic device 130 may also comprise an audio component. In one embodiment reception of video signal 120 by video based electronic device 130 from video source 110 can be accomplished using a direct connection such as a cable. In another embodiment, such a connection can be accomplished through a wireless connection, for example, an IEEE 802.11g, or similar standard. In yet another embodiment, the connection can be accomplished utilizing wideband broadcast techniques.

Video based electronic device 130 comprises at least one processing unit or processor 134, memory 136, frame buffer 138, and decoder 132. Programming instructions for processor 134 are stored in writable, non-volatile memory 136. Program instructions are typically loaded into memory 136 at the time of manufacture of video based electronic device 130 and are executed by processor 134 in the functioning of video based electronic device 130. However, in the event that it is desirable to update the existing program instructions, video source 110 will communicate a video stream 120 to video based electronic device 130 whereby a new version, or a partial version, of program code is encoded into video stream 120. As will be further illustrated, video stream 120 may also include additional information in addition to the encoded program code software. Such information can be, for example, user instructions, human readable information, and/or intermediate machine based coding information.

Video based electronic device 130 receives video stream 120 and stores video stream 120 in frame buffer 138. In another embodiment, video based electronic device 130 allows video stream 120 to pass through frame buffer 138. However, when video stream 120 is encoded with software code, decoder 132, in video based electronic device 130, detects the presence of the encoded software code, decodes the software code from video stream 120 and stores the code in frame buffer 138. Processor 134 has access to frame buffer 138 and therefore executes the decoded software code when notified by decoder 132 of the presence of decoded software code.

Decoded software code may comprise any type of software code, without limitation, whereby the code, when executed by processor 134, can update processor 134's memory 136 with a new program. In another embodiment, the software code may command the processor to execute a single one-time task.

The encoded software code may be encoded within the video stream in a variety of methods. In one embodiment the encoding is accomplished whereby the software code is encoded within a picture component of the video signal. In another embodiment, the software code is encoded within a luminance component of the video signal. In yet another embodiment, the software code is encoded within a chrominance component of the video signal. In yet another embodiment, the software code is encoded within a RGB component of the video signal. In yet another embodiment, the software code is encoded within a vertical blanking component of the video signal. In yet another embodiment, the software code is encoded within a closed caption component of the video signal.

In addition to various methods of encoding program data, the process of encoding the video stream can include an error correction scheme, for example, a repetition scheme, a parity scheme, a checksum, a cyclic redundancy check, a hamming distance based check, a hash function, a horizontal and vertical redundancy check, or a polarity scheme. Such an error correction scheme is used to detect the presence of a transmission error as well as the ability to correct the data error.

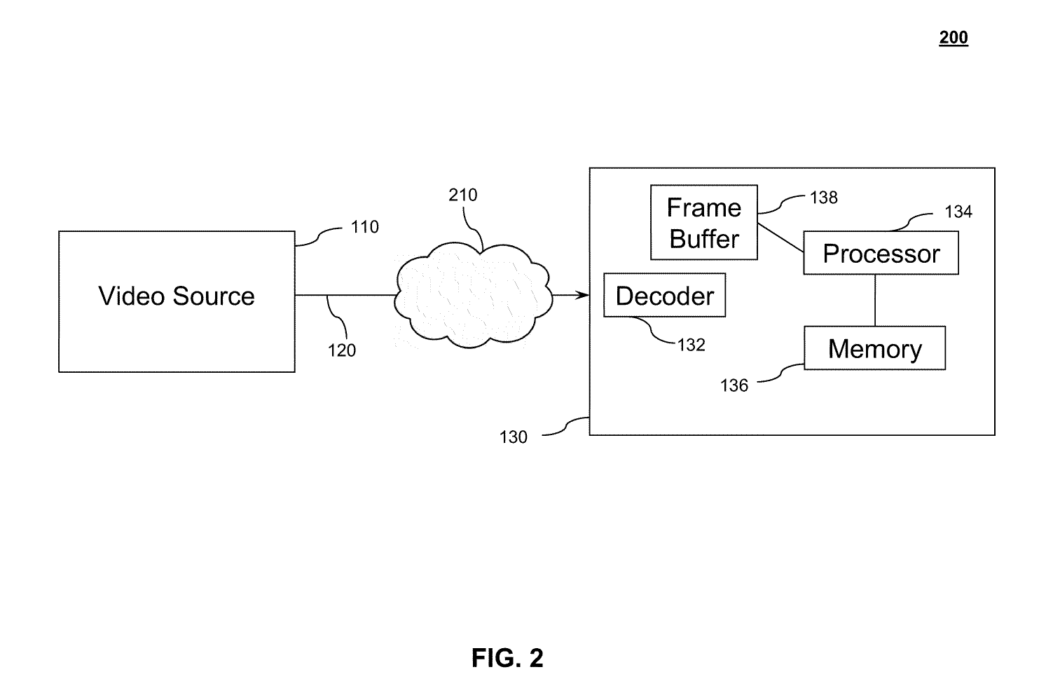

FIG. 2 is an illustration of video based software code updating system 200 using components of system 100 of FIG. 1 in a global communications network. The video based software code updating system 200 includes video source 120 and video based electronic device 130. In a manner similar to the system 100 of FIG. 1, video source 120 communicates with video based electronic device 130, which is comprised of decoder 132, frame buffer 132, processor 134, and memory 136. In system 200 of FIG. 2, however, video source 110 communicates with video based electronic device 130 via a global communications network 210.

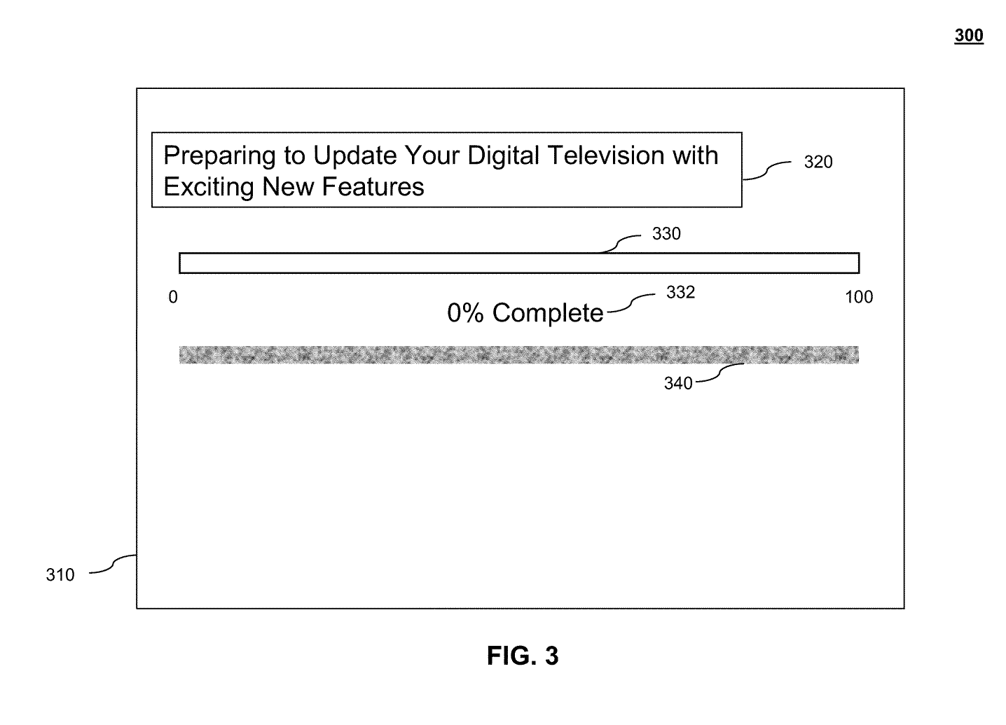

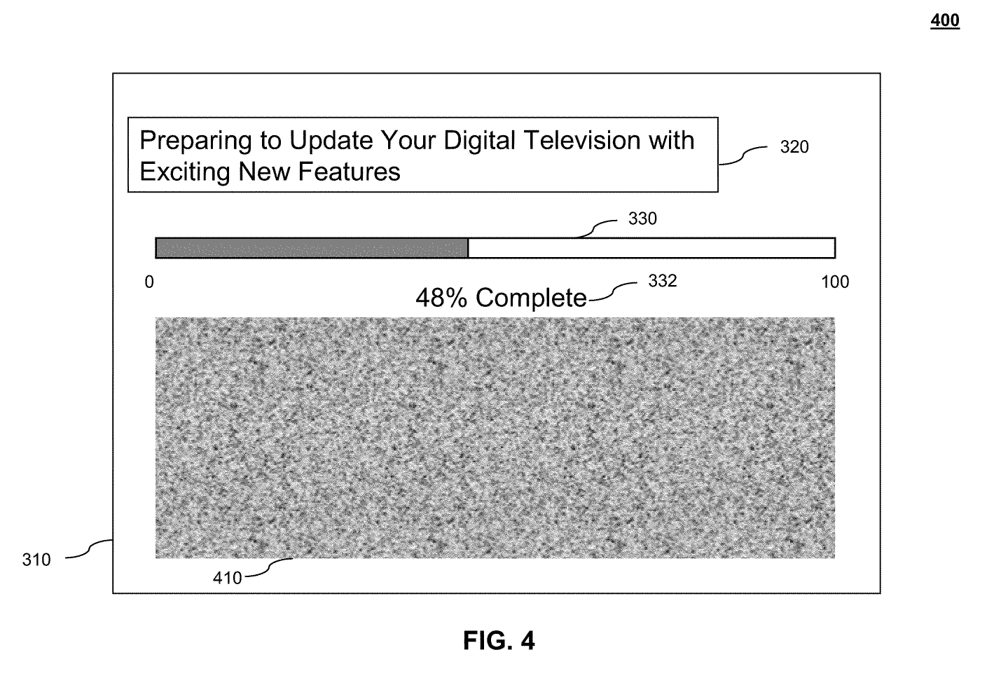

FIG. 3 and FIG. 4 represent examples of a display 300 and display 400, respectively, of a video stream. The video stream can include encoded human readable information within the transmission of a video stream with encoded program data to a video based electronic device according to an embodiment of the present invention. The inclusion of human readable content in an encoded video stream allows for the display of information concerning the communication in addition to the ability for user interaction via a user interface control, including, for example, prompting the user to perform some type of action. Display 300 illustrates viewable screen 310 comprising text box 320, which can display messages and commands to a user, and completion bar 330, a graphical illustration of the completion of the encoded software code task, as well as a numerical percentage 332 indicator to convey to a user an approximate percentage of completion.

Viewable screen 310 also comprises display area 340 which is a visual display of the encoded software code being received. Display area 340 illustrates an example where the encoded software just beginning to be received. FIG. 4 illustrates display 400 with display area 410 indicating the encoded software continuing to be received, in this example, where the graphical and numeric completion bar convey a completion of 48%. Text box 320 may display a multitude of messages, including both textual and graphical messages, with no limitation in terms of size or placement within viewable screen 310.

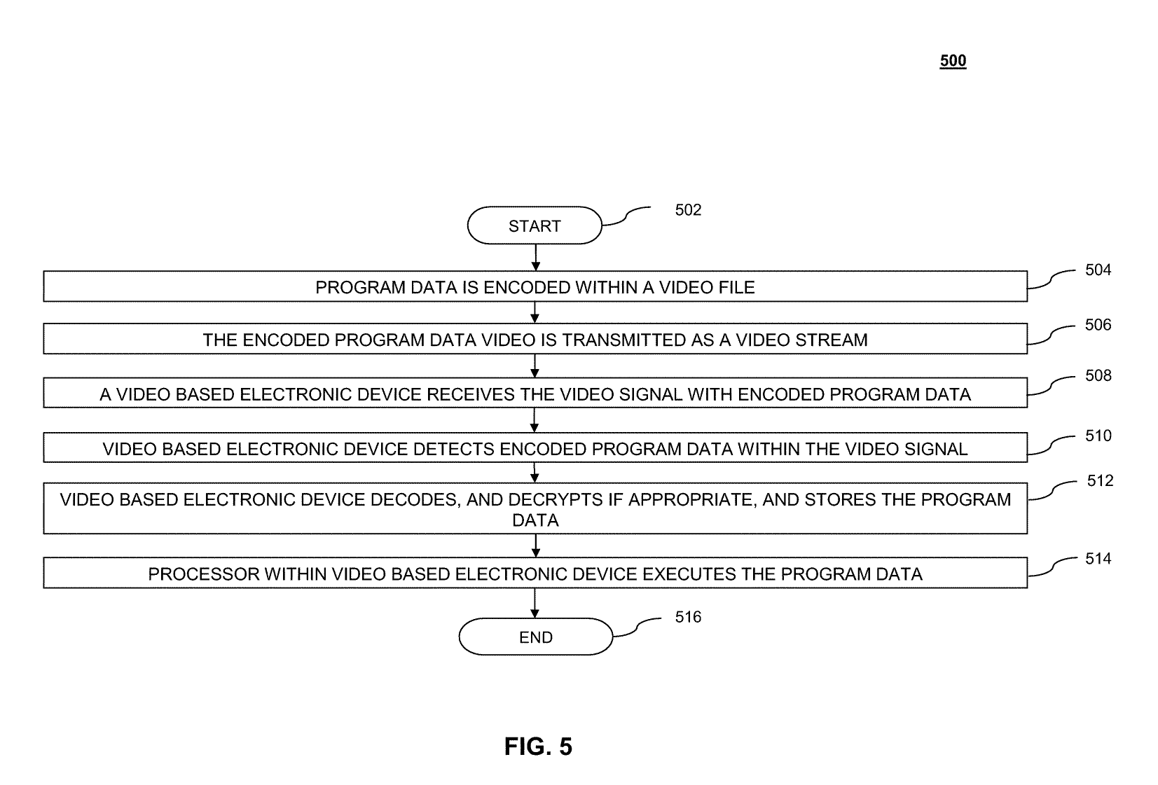

FIG. 5 is a flowchart of exemplary operation 500 of a video based software code updating system in accordance with the present invention. The flowchart starts at step 502, and proceeds to step 504, in which program data in encoded within a video file. In step 506, the encoded program data video is transmitted as a video stream. In step 508, a video based electronic device receives the video signal containing the encoded program data. In step 510, the video based electronic device detects the presence of encoded program data within the video signal. In step 512, the video based electronic device decodes, and decrypts if appropriate, and then stores the program data. In step 514, the processor within the video based electronic device executes the program data. Method 500 ends at step 516.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A video based software code updating system, comprising:
a video signal source; and
a video based electronic device;
wherein the video signal source is configured to transmit a software code encoded within a video stream to the video based electronic device, and
wherein the video based electronic device is configured to detect and decode the software code from within the video stream.

2. The video based software code updating system of claim 1, wherein the video based electronic device comprises a decoder, a frame buffer, a processor, and a memory.

3. The video based software code updating system of claim 1, wherein the video based electronic device comprises a video and an audio component.

4. The video based software code updating system of claim 1, wherein the software code is encoded within a picture component of the video signal.

5. The video based software code updating system of claim 1, wherein the software code is encoded within a luminance component of the video signal.

6. The video based software code updating system of claim 1, wherein the software code is encoded within a chrominance component of the video signal.

7. The video based software code updating system of claim 1, wherein the software code is encoded within a RGB component of the video signal.

8. The video based software code updating system of claim 1, wherein the software code is encoded within a vertical blanking component of the video signal.

9. The video based software code updating system of claim 1, wherein the software code is encoded within a closed caption component of the video signal.

10. The video based software code updating system of claim 1, wherein the video signal source comprises an electronic device configured to display video.

11. The video based software code updating system of claim 1, wherein the video signal source comprises a video broadcast source.

12. The video based software code updating system of claim 1, wherein the video based electronic device communicates with the video signal source utilizing a global communications network.

13. The video based software code updating system of claim 1, wherein the video stream includes an error correction scheme.

14. The video based software code updating system of claim 1, wherein the encoded software code is encrypted with the video based electronic device decrypting the encrypted encoded software code.

15. The video based software code updating system of claim 1, wherein the video stream includes human readable information.

16. The video based software code updating system of claim 15, wherein the human readable information includes a user interface control.

17. A video based software code updating method, comprising:
generating a video stream that is encoded with software code; and
transmitting the video stream to a video based electronic device.

18. The method of claim 17, wherein the software code includes human readable information when displayed on a video based electronic device.

19. The method of claim 17, wherein the software code is encrypted.

20. A video based software code updating method, comprising:
receiving a video stream that is encoded with software code;
recognizing that the video signal is encoded with software code;
decoding such software code from the video stream;
storing the decoded software code in memory;
executing the stored software code; and
performing the functions associated with the software code.

21. The method of claim 20, wherein the software code includes human readable information when displayed on a video based electronic device.

22. The method of claim 20, further comprising, when the software code is encrypted, decrypting the software code.
